(19) United States
(12) Patent Application Publication
(10) Pub. No.: US 2002/0123966 A1
(43) Pub. Date: Sep. 5, 2002

(54) System and method for administration of network financial transaction terminals

(76) Inventors: Luke Chu, Temple City, CA (US); Mark Sullivan, Venice, CA (US)

Correspondence Address: KILPATRICK STOCKTON LLP, 607 14TH STREET, N.W., SUITE 900, WASHINGTON, DC, 20005, US

(21) Appl. No.: 09/885,674

(22) Filed: Jun. 20, 2001

Related U.S. Application Data
(60) Provisional application No. 60/213,815, filed on Jun. 23, 2000.

(51) Int. Cl. G06F 17/60

(52) U.S. Cl. 705/43

(57) ABSTRACT

A system and method for administration of network transaction terminals, such as automated teller machines (ATMs) utilizes queued components to allow a synchronized guaranteed delivery of messages, such as log event messages. The messages, which are formatted as Extensible Markup Language (XML) documents, are sent over a network via a secure authenticated and encrypted delivery mechanism. Once the messages reach a data collector in a secure data center, the messages are propagated into a data repository, and the stored messages can be analyzed using a management tool. A distributed secure instrumentation query tool and a message filtering and event alert feature of the system facilitate a data query by a user.

### PRIORITY APPLICATION

This application claims the benefit of U.S. Provisional Application No. 60/213,815 filed Jun. 23, 2000, entitled “System and Method for Administration of Network Financial Transaction Terminals (Secure Event Logging)”, which is incorporated herein by this reference.

### FIELD OF THE INVENTION

This application relates generally to network financial transactions terminals, and in particular to a reliable system and method for administration of network financial transaction terminals, such as automatic teller machines (ATMs).

### BACKGROUND

There is a current need for a method and system for secure event logging which provides a secure means of acquiring event logging data off of network financial transaction terminals or ATMs. Financial institutions, such as banks, have a current requirement to be able to gather the event logging data off of ATMs and other financial self service delivery devices in a secured and guaranteed fashion. Event logging data comprise system events and application generated events on the ATMs and other systems that are stored in the standard event log on the system. There is a standard event logging mechanism that exists on these systems to simply capture system events, application events, and security events. It is imperative that financial institutions be able to get that event log off of the local system up to a secure data collector located, for example, in a data center and under very strict audit control, in a secure fashion so that financial institution personnel can audit and understand what is occurring on the ATMs. Previous attempts to deal with this requirement for the guaranteed secure delivery or capture of the event log data have been largely unsuccessful in that they do not, for example, prevent unauthorized third parties from tampering with the event log data before it arrives at its intended destination, so it is not a guaranteed delivery solution. For example, a party may perform unauthorized or illegal activity on the ATM and then go in and erase the events of such activity before the events are uploaded, so there is no way for the auditors to discover the activity.

### SUMMARY OF THE INVENTION

It is a feature and advantage of the present invention to provide a system and method for acquiring event logging data off of network financial transaction terminals, such as ATMs, which is reliable, scaleable, secure and real time.

It is another feature and advantage of the present invention to provide a system and method for acquiring event-logging data off of network financial transaction terminals, which is flexible and easy to maintain.

It is an additional feature and advantage of the present invention to provide a system and method for acquiring event-logging data off of network financial transaction terminals, which can be adapted as a monitoring tool to monitor the current status of any number of ATMs.

It is a further feature and advantage of the present invention to provide a system and method for acquiring event-logging data off of network financial transaction terminals, which can also be used to collect data from various system built-in providers.

It is still another feature and advantage of the present invention to provide a system and method for acquiring event logging data off of network financial transaction terminals, which can be used for data automation.

It is another feature and advantage of the present invention to provide a system and method for acquiring event logging data off of network financial transaction terminals that includes a distributed secure instrumentation query tool and a message filtering and event alert feature to facilitate the data query.

To achieve the stated and other features and advantages, an embodiment of the present invention provides a method and system for administration of network financial transaction terminals, such as automatic teller machines (ATMs), utilizing computer hardware and software. In the system and method for an embodiment of the present invention, a queued component client on one of the network terminals, such as a network ATM, sends an event query of log event type to a management instrumentation application, such as Windows Management Instrumentation (WMI), and subscribes to the particular event type. Thereafter, when a log event occurs, the queued component client, acting as an event consumer, receives a log event notification and message from the management instrumentation application.

The queued component client, acting as an event consumer, captures and consumes the log event message before the message is written into the event log. The queued component client creates a client site event queue and places the log event message in the client site event queue. The queued component client then sends the log event message in Extensible Markup Language (XML) via the message queuing services components over a network, which can be a proprietary network or a public network, to a server site event queue. The log event message is removed from the server site event queue by a queued component server acting as an event processor. The queued component server, for example, stores the log event message in XML into a database, such as a Structured Query Language (SQL) Server Data Warehouse. Thereafter the stored log event message can be analyzed using a management tool, such as Online Analytical Processing (OLAP) coupled with Data Warehouse.

The system and method for an embodiment of the present invention also includes a distributed secure instrumentation query tool and a message filtering and event alert feature to facilitate a data query by a user. The user can query the database via a web browser user interface which prompts the user to enter selections. The query results are filtered based on the user's selections, and a report of the filtered results are displayed for the user via the user interface. Further, a notice of a security related event is sent as an event notification to a predefined terminal for a system administrator when the security related event is detected by a filtering mechanism associated with the database.

Additional objects, advantages and novel features of the invention will be set forth in part in the description which follows, and in part will become more apparent to those skilled in the art upon examination of the following, or may be learned by practice of the invention.

### BRIEF DESCRIPTION OF THE DRAWINGS

FIG. 1 is a schematic diagram which shows an example overview of network financial transaction terminals, such as automated teller machines (ATM)s, administered using the distributed secure event logging (DSEL) system for an embodiment of the present invention;

FIG. 2 is a schematic diagram which illustrates an overview example of key components and the flow of information between key components of WMI utilized for an embodiment of the present invention;

FIG. 3 is a schematic diagram which illustrates an overview example of key components and the flow of information between key components of the DSEL system for an embodiment of the present invention;

FIG. 4 is a flow chart which illustrates an example of the distributed secure event logging process for an embodiment of the present invention;

FIG. 5 is a table which illustrates examples of devices for which real time data can be collected utilizing the DSEL system for an embodiment of the present invention;

FIG. 6 is a schematic flow diagram that illustrates another overview example of key components and the flow of information between key components of the DSEL system for an embodiment of the present invention;

FIG. 7 is a schematic diagram which provides further details regarding an example of the flow of information between the DSEL Client, DSEL Server, and SQL Server components of the system for an embodiment of the present invention;

FIGS. 8 and 9 show top and bottom portions, respectively, of a sample DSI Query user interface (UI) for the DSI Web Query Tool for an embodiment of the present invention; and

FIG. 10 shows a sample DSI Query report UI for the DSI Web Query Tool for an embodiment of the present invention.

### DETAILED DESCRIPTION

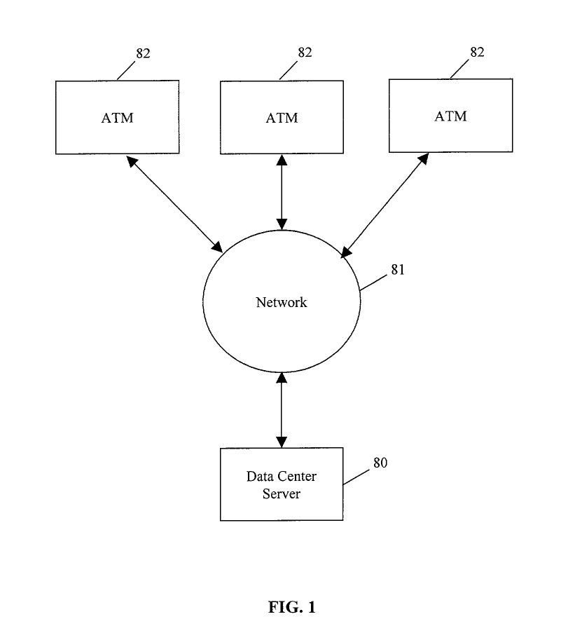

Referring now in detail to an embodiment of the invention, an example of which is illustrated in the accompanying drawings, the system and method of the present invention provides distributed secure event logging (DSEL) application software that meets audit trail and violation alter management standards defined, for example, by security officers of a financial institution, such as a global bank. The DSEL application can be deployed in-house or to other financial institution business units, or it can be licensed to other entities. The DSEL application involves implementation, for example, of Windows Management Instrumentation (WMI) and provides a reliable tool for better administration of network financial transaction terminals, such as automated teller machines (ATMs). FIG. 1 is a schematic diagram which shows an example overview of network financial transaction terminals, such as ATMs 82, administered using the DSEL application for an embodiment of the present invention. The system of the present invention utilizes, for example, the WMI provided on Windows-based systems that exposes event log data. This aspect enables a small amount of code to be written that makes it possible to tie in and gain access to the event log data in real time before it can be tampered with. An embodiment of the present invention involves, for example, tying into WMI to provide event log data to a financial institution, such as a bank. In addition, the DSEL application also provides a guaranteed delivery of the data across the wire.

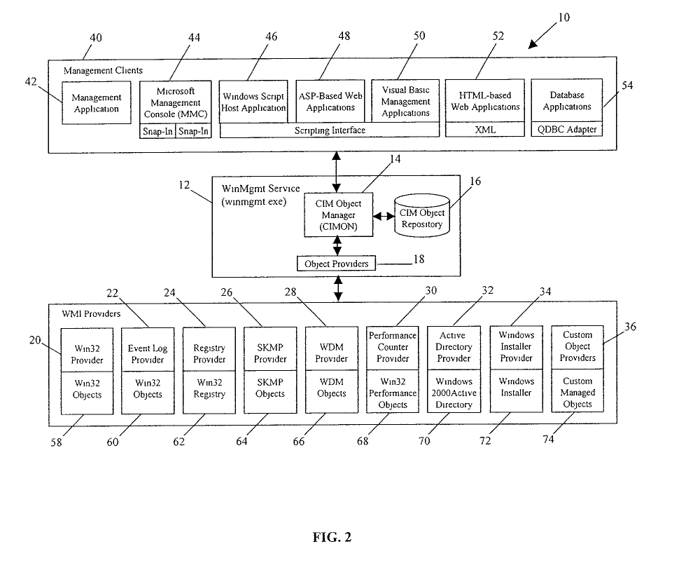

FIG. 2 is a schematic diagram which illustrates an overview example of key components and the flow of information between key components of WMI utilized for an embodiment of the present invention. The DSEL application can be implemented on various Microsoft Windows platforms and uses, for example, portions of WMI 10 and COM+ features of Windows 2000 architecture. The WMI architecture makes use of WinMgmt Service (winmgmt.exe) 12, including CIM Object Manager (CIMOM) 14, CIM Object Repository 16, and Object Providers 18. WMI Providers include Win32 Provider 20, Event Log Provider 22, Registry Provider 24, SNMP Provider 26, WDM Performance Counter Provider 28, Active Directory Provider 30, Windows Installer Provider 34, and Custom Object Providers 36. WMI Management Clients 40 include Management Application 42, Microsoft Management Console (MMC) 44, Windows Script Host Applications 46, ASP-Based Web Applications 48, Visual Basic Management Applications 50, HTML-based Web Applications 52, and Database Applications 54.

WMI 10 is one of several technologies introduced by Microsoft to support the management of systems in an enterprise environment. Essentially, WMI 10 includes a rich group of built-in system providers 18 that can be used to manage Windows-based systems, such as Windows 95, 98, NT, and 2000. WMI 10 also allows users to write their own custom providers for applications and add-on hardware devices. All network systems, applications, and add-on device information exposed as an instrument can be accessed locally and remotely through WMI 10 from these providers 18. For the DSEL application running, for example, on Windows NT and Windows 2000, the Win32_NTLogEvent WMI built-in system provider 22 is used to capture local real time log event data prior to its being written to the NT application event log.

Web-Based Enterprise Management (WBEM) is an initiative undertaken by the Distributed Management Task Force (DMTF) to provide enterprise system managers with a standard, low-cost solution for their management needs. The WBEM initiative encompasses a multitude of tasks, ranging from simple workstation configuration to full-scale enterprise management across multiple platforms. Central to the initiative is the Common Information Model (CIM), an extensible data model for representing objects that exist in typical management environments, and the Managed Object Format (MOF) language for defining and storing modeled data.

WMI 10 is an implementation of the WBEM initiative for Microsoft Windows platforms. By extending the CIM to represent objects that exist in WMI environments and by implementing a management infrastructure to support both the MOF language and a common programming interface, WMI 10 enables diverse applications, such as the Management Clients 40, to transparently manage a variety of enterprise components, such as Win 32 Objects 58, Win32 Event Log 60, Win32 Registry 62, SNMP Objects 64, WDM Objects 66, Win 32 Performance Counters 68, Windows 2000 Active Directory 70, Windows Installer 72, and Custom Managed Objects 74, as shown in FIG. 2. The components of the WMI infrastructure include the actual WMI software (Winmgmt.exe) 12, which is a component that provides applications with uniform access to management data, and the Common Information Model (CIM) Object Repository 16, which is a central storage area for management data.

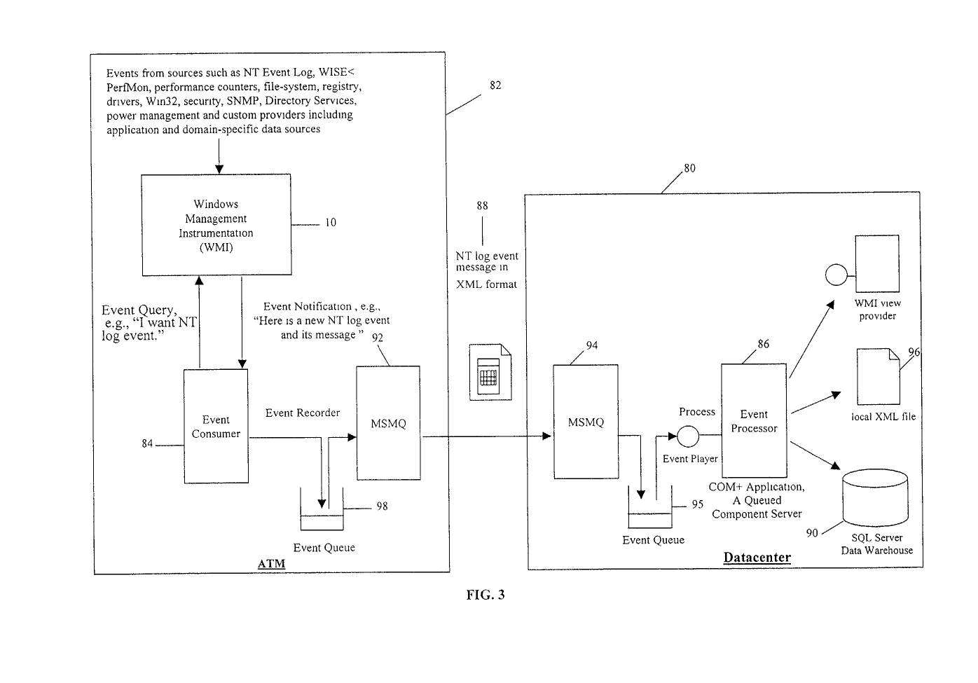

FIG. 3 is a schematic diagram which illustrates an overview example of key components and the flow of information between key components of the DSEL system for an embodiment of the present invention. The present invention makes use of a client-server architecture. On the server side 80, there is a server application running, and on the ATM machine 82, there is a client application. It is scaleable, so it can grow proportionally. In a broader view, on the server side 80, there are Component Object Model (COM) components, and there is message and interface utilized remotely. It is actually a Distributed Component Object Model (DCOM) technology and involves communicating between a client and server via the DCOM and thus said to be proprietary, but it can be implemented over the Internet. It is fully encrypted and authenticated, which is also a key aspect of an embodiment of the present invention.

Component Object Model Plus (COM+) is another new technology offered by Windows 2000 and is an enhancement and extension to existing component services. The DSEL application for an embodiment of the present invention utilizes Queued Component, which is one of the COME component services. Briefly, a Queued Component uses Message Queuing Services (MSMQ) as the underneath transmission mechanism and allows clients to invoke methods on local or remote COM+ application components using an asynchronous model. Referring to FIG. 3, the DSEL application utilizes WMI 10 and Queued Component and contains basically two Queued Components. One Queued Component is a Queued Component Client 84 running on an ATM 82 or any desktop computer, and the other is a Queued Component Server 86 running on a remote Data Center machine 80. WMI 10 can retrieve events from either built-in system provider data sources or custom provider data sources.

Referring further to FIG. 3, the system and method of the present invention makes use of Queued Components 84, 86 based, for example, on Microsoft message queue technologies, to allow a synchronized guaranteed delivery of messages, such as NT log event message 88. The messages, such as NT log event message 88, are formatted as Extensible Markup Language (XML) documents, so that it is an extensible message format. The present invention leverages Internet Protocol (IP) secure communications or other Virtual Private Network (VPN) technologies across the wire to make it a secure authenticated and encrypted delivery mechanism. Once the data reaches a data collector, such as Event Processor 86, in the secure data center 80, it is then propagated into a data repository, such as Data Warehouse 90, in a secure fashion. It is all transactional across the wire, so that it is a guaranteed mechanism. If the data collector 86 does not pick up the data, it remains in the queue 95, and as soon as the data collector 86 becomes available, the data collector 86 picks up the data and provides guaranteed delivery of it.

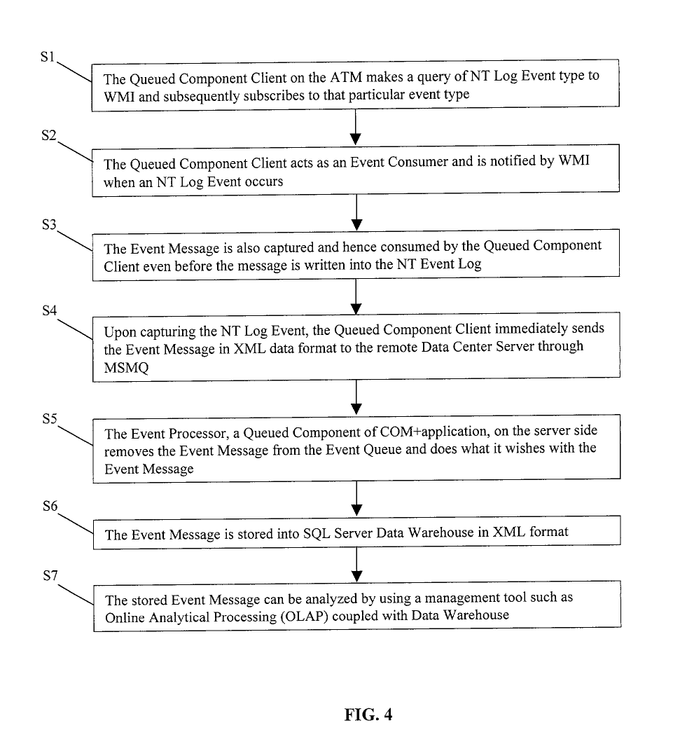

FIG. 4 is a flow chart which illustrates an example of the distributed secure event logging process for an embodiment of the present invention. Referring to FIG. 4, at S1, the DSEL Queued Component Client 84 on the ATM 82 makes a query of NT Log Event type to WMI 10 and subsequently subscribes to that particular event type. Thereafter, at S2, the Queued Component Client 84 acts as an event consumer and is notified by WMI 10 when an NT Log Event occurs. In addition, at S3, the Event Message 88 is also captured and hence consumed by the Queued Component Client 84 even before the message is written into the NT Event Log. At S4, upon capturing the NT Log Event, the Queued Component Client 84 immediately sends the Event Message 88 in XML data format to the remote Data Center Server 80 through MSMQ 92, 94. Referring further to FIG. 4, at S5, the DSEL Server Component, Event Processor 86, a Queued Component of COM+ application, on the server side 80 then removes the Event Message 88 from the Event Queue 95 and does whatever it wishes with the Event Message 88. For example, in an embodiment of the present invention, at S6, the Event Message 88 is sent and stored into SQL Server database 90 in XML format. At S7, the stored Event Message 88 can be analyzed by using a management tool such as Online Analytical Processing (OLAP) coupled with Data Warehousing 90 to provide more efficient and dynamic real-time data query and safer data management.

The WMI 10 is Microsoft's implementation of a standard management set of services that allows one to basically expose what is going on in the system and to instrument the system. WMI 10 is the service that Microsoft provides and to which the financial institution subscribes. Thus, getting the event log data in the first place is provided through a standard mechanism. An embodiment of the present invention provides for guaranteed delivery of the event log data, which involves, for example, queuing and encryption technology. In the process of getting from the ATM 82 up to the Data Warehouse 90, the Event Message 88 first goes into the publishing mechanism of the WMI 10 to which the financial institution is a subscriber. Thus, the financial institution is notified of data, which is local to the system. Once an item of data is published by WMI 10, and the financial institution's subscriber 84 receives it, an Event Queue 98 is created locally. The data is put into an outgoing Event Queue 98, and Message Queuing Services (MSMQ) components 92, 94 actually deliver the Log Event Message 88 across the wire. It is then picked up on an Event Queue 95 on the other side 80 where the financial institution has a collector 86 that is reading out of the Event Queue 95 and populating it into a repository, such as Data Warehouse 90. The data can be delivered by the MSMQ components 92, 94 across any network 81, such as a proprietary network or the Internet.

An important aspect of an embodiment of the present invention is that because it is XML based and is extensible, it can provide guaranteed delivery and authentication of any data text that can be instrumented off of the system. Thus, while an embodiment of the present invention involves getting log events out of WMI 10, it is not limited to that, but also applies to getting any other type of data out of WMI 10, such as applications, specific data, data regarding security events, and all kinds of different data that can be provided through WMI 10. The guaranteed delivery and data collection of any of that data can be accomplished through the mechanism for an embodiment of the present invention, a key aspect of which is its extensible nature.

The mechanism for an embodiment of the present invention is entirely automatic and unattended, but once the data is in the repository, such as Data Warehouse 90, it is available for straight querying. Financial institution personnel can go through and simply look at the event logs as they would have looked at them locally to the system. The financial institution personnel can also do value added querying, such as performing analysis across the logs, or performing aggregate type of viewing of the logs, such as looking at multiple systems at the same time. That is an example of what is enabled by getting the event logs back into the data collector 86 and into the repository 90. In the system and method for an embodiment of the present invention, the data can come into the data repository 90 from ATMs 82 deployed worldwide, but it may be more convenient, for example, for ATMs 82 deployed in one country, such as the U.S., to have their own data center 80 and data collector 86 and for ATMs 82 deployed in another country, such as Germany, to have their own data center 80 and data collector 86. While the regional configuration may be more convenient, the system for an embodiment can be configured on a global basis, as well.

The implementation of DSEL for an embodiment of the present invention offers many overall advantages, such as reliability, scalability, and secure real time data collection. For example, data delivery from client 82 to server 80 is guaranteed by MSMQ, and the client and server model can grow proportionally. Further, the NT log event is captured in real time as it occurs, prior to when the message content is written to the log, and the NT log event is sent to the server 80 immediately. Thus, there is absolutely no chance for data tampering at the client site 82 under normal circumstances. This important feature is not currently provided by existing security managers, which use near real time data collection that can result in a possibility for data tampering. The transmission of a message from client 82 to server 80 in the system for an embodiment of the present invention is secure, since only an authorized client 82 can access the message queue 98.

Other advantages of implementation of DSEL for an embodiment of the present invention include flexibility, better maintenance, and monitoring. For example, clients 82 can send events to the remote server 80 asynchronously regardless of whether the server 80 is up or not. When any ATM 82 is down, a copy of its NT log is always available prior to the down time at the server site 80 that can be used to debug the problem without touching the particular ATM machine 82. Since the data is collected in real time, it can be adapted as a monitoring tool to monitor the current status of all ATMs 82, if desired.

Another advantage of implementation of DSEL for an embodiment of the present invention is that it enables creation of a Data Warehouse 90. Other than collecting data from NT Log Event 22, data can also be collected from various system built-in providers, such as Win 32 Provider 20, Registry Provider 24, SNMP Provider 26, WDM Provider 28, Performance Counter Provider 30, Active Directory Provider 32, Windows Installation Provider 34, and/or Custom Object Providers 36, including application and domain-specific data sources. A further advantage of implementation of DSEL for an embodiment of the present invention is that it enables data automation by using online analytical processing (OLAP) type tools. By using predefined database schema and query, the stored data can be correlated in an automatic fashion. For example, ATM uptime and downtime can be calculated automatically, instead of manually handling the data as is the current practice.

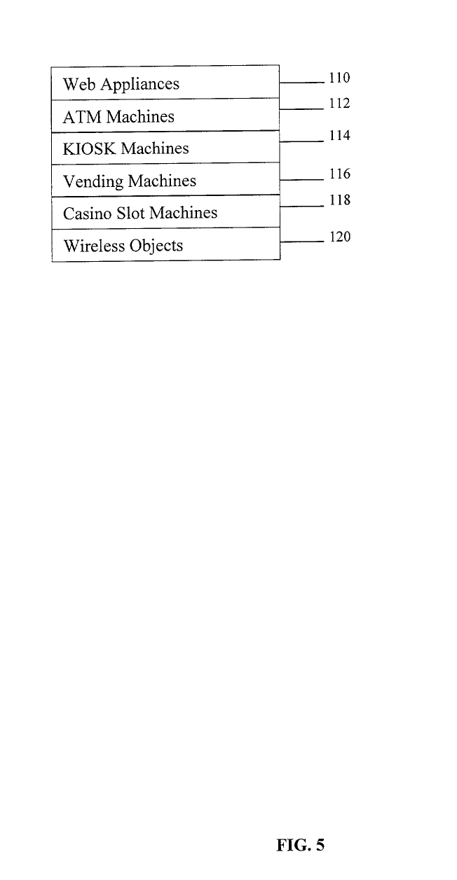

FIG. 5 is a table which illustrates examples of devices for which real time data can be collected utilizing the system and method for an embodiment of the present invention. The potential for the system of the present invention is enormous, since it can be applied to numerous business system scenarios that are suitable. The system can be set up for real time data collection and system management for devices, such as web appliances 110, ATM machines 112, kiosk machines 114, vending machines 116, casino slot machines 118, and wireless objects 120. For example, with regard to web appliances 110, real time data can be collected on the status of all kinds of web clients such as home or commercial security systems, dishwashing machines, refrigerators, and Web TVs. For ATM machines 112, real time data can be collected, for example, on the status of the ATM and critical devices. With respect to kiosk machines 114, real time data can be collected on the current up or down status, and for vending machines 116, real time data can be collected on the up or down and inventory replenishment status. For casino slot machines 118, real time data can be collected on the up or down and coins remaining status. Further, with regard to wireless objects 120, real time data can be collected on rental cars, vehicles, and aircraft, for example, for better maintenance service.

A number of applications can be developed using the technology utilized for an embodiment of the present invention, such as system management tools, remote operator interface and monitoring tools, and MIS logging tools. For example, with regard to system management tools, using WMI 10 and Microsoft Management Console (MMC) 44 together can provide a comprehensive view and control of all systems for any given enterprise, such as a bank. For a banking kiosk 114, applications can be developed for system status, such as uptime and downtime, for data collection, such as new account statistics, and for printer status. In addition, applications can be developed for banking server data collection, and ATM status and devices data collection, such as change registry and/or install or uninstall software. Further, applications can be developed for remote operator interface and monitoring that provides a local centralized control and monitoring tool that is particularly useful for bank branches having a large number of ATMs. Additionally, applications can be developed for MIS logging, for example, for sending MIS logs to a remote server for analysis.

The use of WMI 10 enables tremendous business opportunities for exploitation. The development of DSEL for an embodiment of the present invention using WMI 10 and COM+ Queued Component not only leverages cutting edge technologies to seek possible goals for the future, but also brings great value to the enterprise at the same time. In addition, not only does the DSEL application for an embodiment of the present invention fulfill the security requirement for a financial institution, such as a bank, but it can also be packaged as a commercial software product and sold to other entities that use and demand such secure event logging capability. Implementation of DSEL for an embodiment of the present invention provides numerous advantages over existing security managers and affords a better business solution in terms of reliability, scalability, complete security, flexibility, and better management.

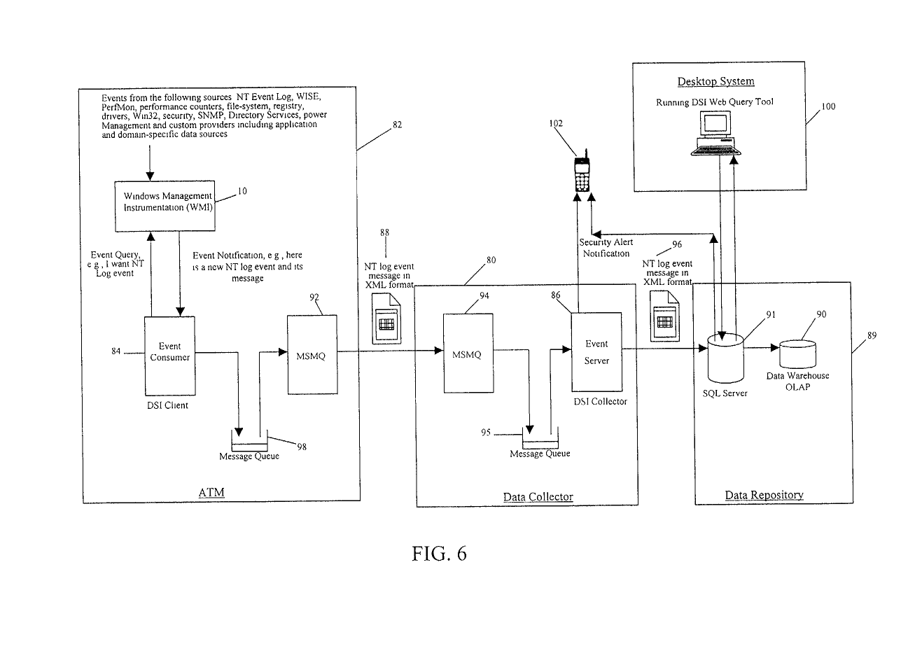

FIG. 6 is a schematic flow diagram that illustrates another overview example of key components and the flow of information between key components of the DSEL system for an embodiment of the present invention. Referring to FIG. 6, to add value to the DSEL application, an embodiment of the present invention includes, for example, monitoring and management capabilities to facilitate the data query and event alert process, such as a Distributed Secure Instrumentation (DSI) Query tool 100 and a message filtering and event alert feature 102. The DSI Query tool 100 provides a standard Web Browser user interface for querying the Data Repository 89, and the message filtering and event alert feature 102 informs system administrators in case of security intrusions or violations of interests. The Web based SQL Query utility 100 can be used from any desktop system from anywhere in the world to query any information against the SQL Data Repository 89.

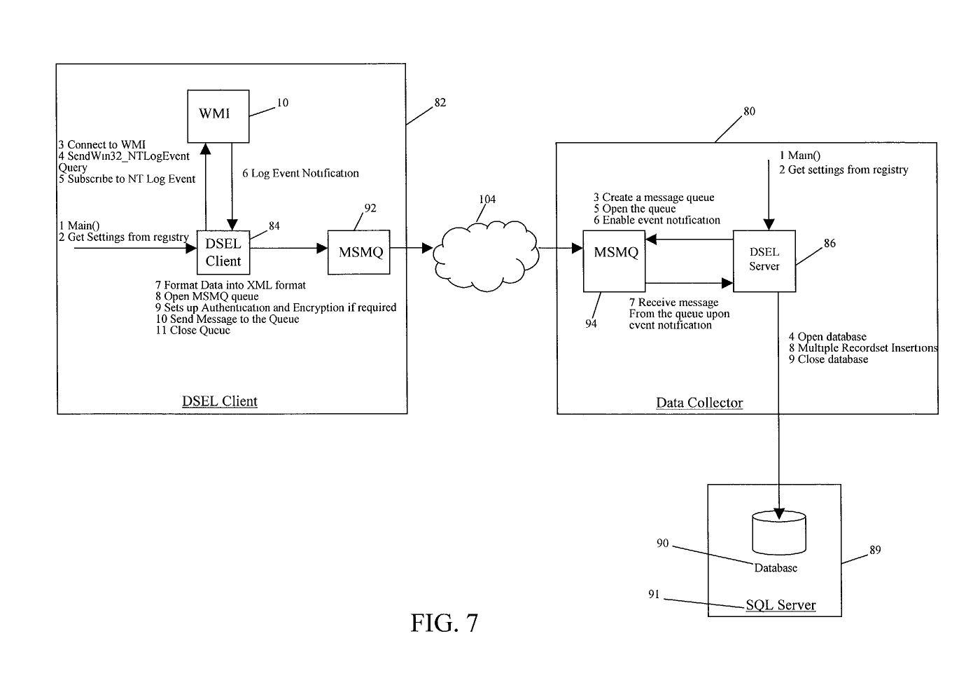

FIG. 7 is a schematic diagram which provides further details regarding an example of the flow of information between the DSEL Client 82, DSEL Server 80, and SQL Server components 89 of the system for an embodiment of the present invention. The SQL Server database 90 is on the Data Repository site 89 to store the messages processed and forwarded from the Data Collector 80. For better system security management, the event filtering and notification feature 102 based on the built-in functions of the SQL Server 91, is configured and set up to notify a predefined media receiver, such as a cell phone, pager, and/or email, for any filtered message. For example, upon detection of a virus intrusion message by the SQL filtering mechanism, an email can be sent as an event notification to an administrator's cell phone 102 immediately.

The implementation of the DSEL architecture for an embodiment of the present invention supports numerous features, such as reliability, scalability, total security, real time processing, flexibility, better maintenance, monitoring, data warehousing and OLAP, and cluster service and fault tolerance. For example, message delivery from Clients 82 to Server 80 is guaranteed by MSMQ 92, 94. Especially, messages sent by Clients 82 are guaranteed delivery exactly one time to the Data Collector 80, and no duplicate messages are sent. Messages can persist across temporary system and network failures. When messages cannot be delivered to the Server queue 95, MSMQ 92, 94 automatically stores the messages and retries sending the messages when the failure has recovered. Further, with regard to scalability, the client and server model can grow proportionally. Typically in a distributed enterprise network, either more regional Data Collectors 80 can be added, or the SQL Server 91 can be configured in a cluster model.

With respect to security, at the MSMQ message level, the transmission of messages from Client 82 to Server 80 is secure, since only an authorized Client 82 can access the message queue 98. Optionally, captured event messages can be encrypted while being kept in the local MSMQ queue 98, 95 on both Client 82 and Server 80 sites. Further, at the system level, using Virtual Private Network (VPN) with IPSec in a N-tier network environment enforces end-to-end identity authentication and data encryption. In addition, in regard to real time processing, a WMI NT log event is captured in real time as it occurs prior to the time the message content is written to the log and sent over to the Data Collector 80, immediately. This leaves absolutely no chance for data tampering at the Client site 82 under normal circumstance. This important feature is not provided by prior art systems, since the near real time data collection nature of such systems can result in a possibility for data tampering.

Regarding flexibility, Clients 82 can send messages to the remote Data Collector 80 asynchronously whether or not the Server 86 is up. The Data Collector 80 runs in the same computer that hosts the queue 95. The Data Collector 80 constantly monitors for messages delivered to the queue 95, and retrieves messages from the queue 95. If, for some reason, the DSEL Server 86 software stops operating, new messages can continue to be written into the Server queue 95 until the queue 95 or computer quota has been reached. With respect to better maintenance, whenever any ATM or desktop system is down, there is always a copy of its NT log prior to the down time at the Data Repository site 89 that can be used to debug the problem without touching the particular downed system. Additionally, since the data is collected in real time, it can be adapted as a monitoring tool to view the current status of all Client systems if desired. The Web based DSI Query tool 100 can be used from any desktop system to access the Data Repository 89 in a real time fashion. Also, the event filtering and alert notification feature 102 can be built into the Data Collector 80 or the SQL Server 91 to provide better system management capability.

With reference to data warehousing and OLAP, other than collecting data from NT Log Event, data can also be collected from various system built-in providers such as WISE, PerfMon, performance counters, file system, registry, drivers, Win32, security, SNMP, directory services, power management and custom providers, including application and domain-specific data sources. By using tools provided by SQL Server 91, OLAP type of query functions can be performed. Also, the stored data can be correlated in an automatic fashion, for example, to calculate ATM uptime and downtime automatically, instead of manually handling the data.

With respect to cluster service and fault tolerance, in case of preventing system hardware or software failures on the Data Repository 89, a full system redundancy can be achieved by using the Cluster Service provided by Windows 2000 Advanced Server. One of the fault tolerance features provided by the Windows 2000 Advanced Server is the Two Node Cluster Service, which supports fail-over, caused by hardware or software failure, of mission critical applications, including messaging systems such as MSMQ, databases, knowledge management, enterprise resource planning (ERP), and file and print services. In the event a hardware or software failure occurs in either node, the applications such as the SQL Server currently running on the troubled node is then migrated by Cluster Service to the surviving node and restarted. Because Cluster Service uses a shared-disk configuration with common bus architectures such as SCSI and Fibre Channel, no data is lost during a fail-over.

Referring further to FIG. 6, the DSI Web Query tool 100 utilizes a Web Server configured, for example, via an Installshield Setup. A virtual directory is created, configured to utilize Integrated NT authentication (with no anonymous access), and the files are copied to the correct physical directory. This prevents unauthorized users from running the application, but allows authorized users to launch the application without requiring additional logins. In a COM+ aspect of the DSI Web Query tool 100, a data access component exists (currently as an empty shell with no functional code) to act as a front-end to allow the Web application to check the COM+ role that was assigned to the user and allow either partial, full, or denial of access to the user. An Installshield setup creates the COM+ application, and adds the data access component and creates the roles. The user launches Component Services to add users to the roles. The COM+ application connects to the back-end Data Repository 89 via the account context of sysDSIQuery, which is configured to have full read access to a LogData table. Security is implemented via COM+, the Web Server, and the currently logged-in user who launches the query.

A Web Application for the DSI Web Query tool 100 is an ASP application, utilizing the COM+ data access component to authorize the user, and thereafter, a Query Form is loaded. The user selects from the various fields, the query is submitted, and a report is output to the screen. ADO paging is utilized to maximize performance and to allow the user to resize the page and to jump directly to various pages in the report, or to display all pages so the report can be printed. Navigation links exist on the page, along with links to allow resorting by any column, regeneration of the report, or to start a new query. ASP is the primary technology used to connect to the Data Repository 89 and to authorize the user. Javascript is used to provide the client-side features in both the Query Form and the Query Report. As each selection is made, the proposed SQL statement is updated on the fly. A properly authorized user can see this and edit the SQL to create a custom query.

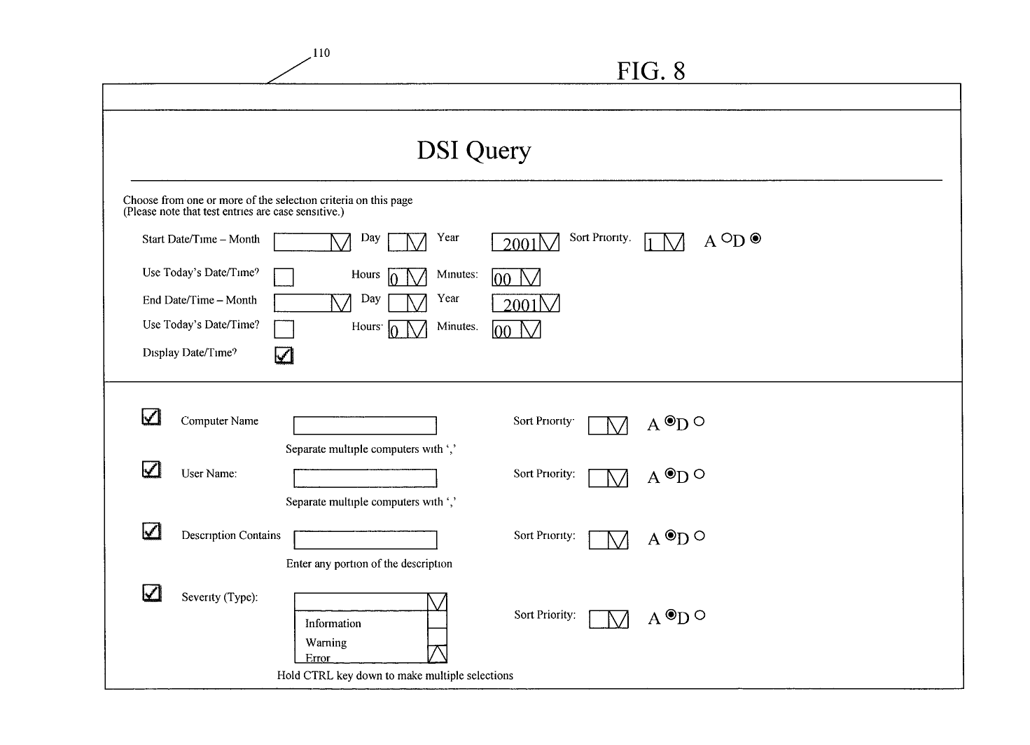

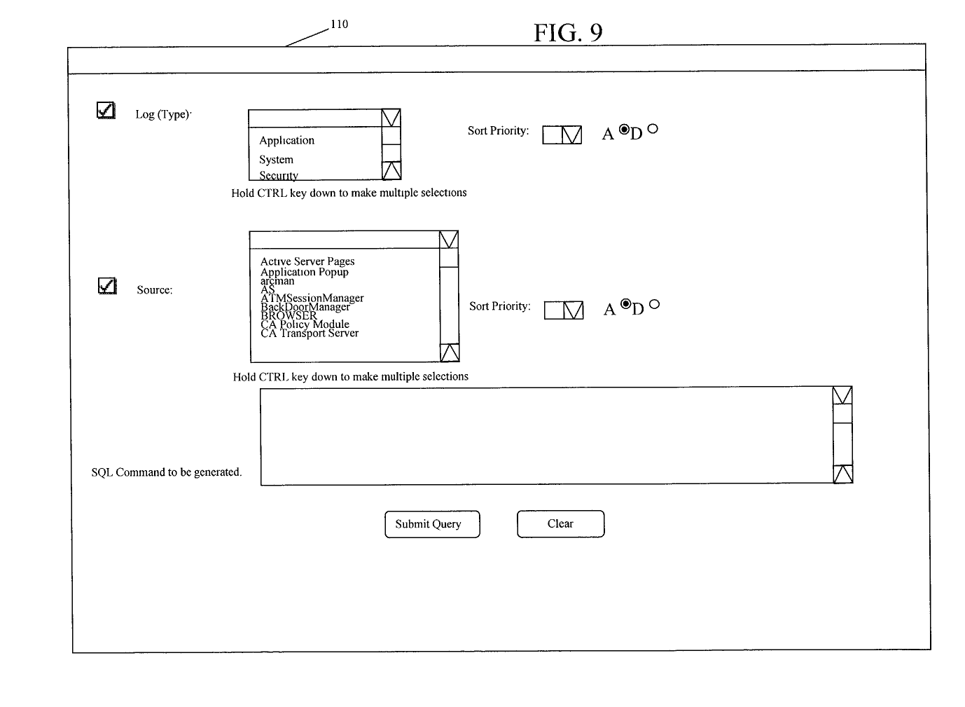

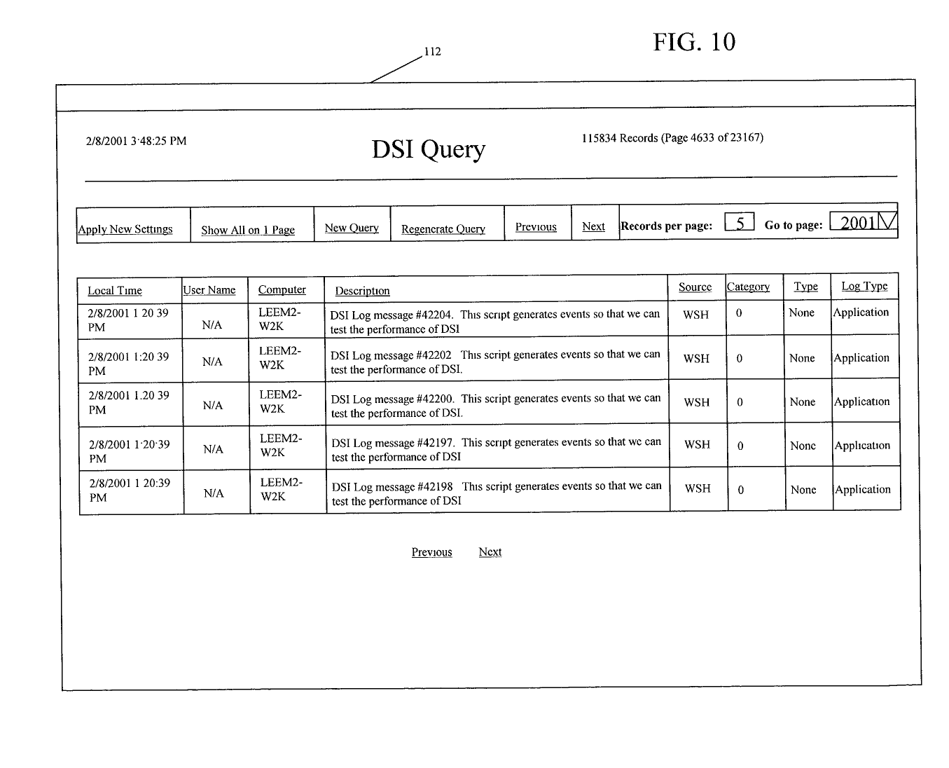

The DSI Web Query Tool 100 provides a standard Web browser user interface for querying the DSI Data Repository 89. With this application, an administrator uses, for example, an Internet Explorer 5.0 Web browser to query the SQL Server database 90 using several columns and values as selection criteria. This application can be hosted on any Web server running, for example, IIS Version 5, which can establish a connection to the SQL Server 91 on the DSI Data Repository 89. FIGS. 8 and 9 show top and bottom portions, respectively, of a sample DSI Query user interface (UI) for the DSI Web Query Tool 100 for an embodiment of the present invention. The DSI Query form 110 presents the user with the options to select the columns that are to be displayed and, based on the user's selection criteria, to determine the data rows that are to be presented. When a query runs, it returns results from the DSI Data Repository 89, filtering the results based on selections made on the DSI Query form 110. FIG. 10 shows a sample DSI Query report UI 112 for the DSI Web Query Tool 100 for an embodiment of the present invention. The DSI Web Query report UI 112 is returned after the user clicks on a Submit Query button on the DSI Query form 110.

Various preferred embodiments of the invention have been described in fulfillment of the various objects of the invention. It should be recognized that these embodiments are merely illustrative of the principles of the invention. Numerous modifications and adaptations thereof will be readily apparent to those skilled in the art without departing from the spirit and scope of the present invention.

What is claimed is:

1. A method for administration of network financial transaction terminals, comprising:
sending an event query to a management instrumentation application by a queued component client on one of the financial transaction terminals;
receiving an event notification from the management instrumentation application by the queued component client;
sending an event message to a server site event queue by the queued component client via message queuing services components;
removing the event message from the server site event queue by a queued component server; and
storing the event message into a database by the queued component server.

2. The method of claim 1, wherein sending the event query further comprises sending a log event type of event query to the management instrumentation application.

3. The method of claim 2, wherein sending the log event type of event query further comprises subscribing to the log event type by the queued component client.

4. The method of claim 1, wherein receiving the event notification further comprises receiving log event type of event notification by the queued component client.

5. The method of claim 4, wherein receiving the event notification further comprises receiving the event notification by the queued component client acting as an event consumer.

6. The method of claim 5, wherein receiving the event notification by the queued component client acting as the event consumer further comprises capturing and consuming a log event message by the queued component client.

7. The method of claim 6, wherein receiving the event notification by the queued component client further comprises capturing and consuming the log event message by the queued component client before the log event message is written into an event log.

8. The method of claim 7, wherein receiving the event notification further comprises placing the log event message in a client site event queue by the queued component client.

9. The method of claim 8, wherein receiving the event notification further comprises creating the client site event queue by the queued component client.

10. The method of claim 4, wherein receiving the event notification further comprises receiving the event notification by the queued component client from the management instrumentation application when a log event occurs.

11. The method of claim 1, wherein sending the event message further comprises sending a log event message in extensible markup language to the server site event queue by the queued component client.

12. The method of claim 11, wherein sending the log event message further comprises placing the log event message in a client site event queue by the queued component client.

13. The method of claim 12, wherein placing the log event message in the client site event queue further comprises creating the client site event queue by the queued component client

14. The method of claim 11, wherein sending the log event message further comprises sending the log event message to the server site event queue over a network.

15. The method of claim 14, wherein sending the log event message over the network further comprises sending the log event message to the server site event queue over a proprietary network.

16. The method of claim 14, wherein sending the log event message over the network further comprises sending the log event message to the server site event queue over a public network.

17. The method of claim 1, wherein removing the event message further comprises removing a log event message from the server site event queue by the queued component server.

18. The method of claim 17, wherein removing the log event message further comprises removing the log event message in extensible markup language format from the server site event queue by the queued component server.

19. The method of claim 18, wherein removing the log event message further comprises removing the log event message from the server site event queue by the queued component server acting as an event processor.

20. The method of claim 1, wherein storing the event message further comprises storing a log event message into the database by the queued component server.

21. The method of claim 20, wherein storing the log event message further comprises storing the log event message in extensible markup language format into the database by the queued component server.

22. The method of claim 21, wherein storing the log event message further comprises storing the log event message into a structured query language server data warehouse by the queued component server.

23. The method of claim 22, wherein storing the log event message further comprises analyzing the stored log event message.

24. The method of claim 23, wherein analyzing the stored log event message further comprises analyzing the stored log event message using an online analytical processing application.

25. The method of claim 1, further comprising allowing a user to query the database via a web browser user interface.

26. The method of claim 25, wherein allowing the user to query the database further comprises filtering query results based on selections entered by the user on the user interface.

27. The method of claim 26, wherein filtering the query results further comprises displaying a report of the filtered results for the user via the user interface.

28. The method of claim 1, further comprising sending a notice of a security related event as an event notification to a predefined terminal for a system administrator.

29. The method of claim 28, wherein sending the notice of the security related event further comprises detecting the security event by a filtering mechanism associated with the database.

30. A system for administration of network financial transaction terminals, comprising:
means for sending an event query to a management instrumentation application by a queued component client on one of the financial transaction terminals;
means for receiving an event notification from the management instrumentation application by the queued component client;
means for sending an event message to a server site event queue by the queued component client via message queuing services components;
means for removing the event message from the server site event queue by a queued component server; and
means for storing the event message into a database by the queued component server.

31. The system of claim 30, wherein the means for sending the event query further comprises means for sending log event type of event query to the management instrumentation application.

32. The system of claim 31, wherein the means for sending the log event type of event query further comprises means for subscribing to the log event type by the queued component client.

33. The system of claim 30, wherein the means for receiving the event notification further comprises means for receiving a log event type of event notification by the queued component client.

34. The system of claim 33, wherein the means for receiving the event notification further comprises means for receiving the event notification by the queued component client acting as an event consumer.

35. The system of claim 34, wherein the means for receiving the event notification by the queued component client acting as the event consumer further comprises means for capturing and consuming a log event message by the queued component client.

36. The system of claim 35, wherein the means for receiving the event notification by the queued component client further comprises means for capturing and consuming the log event message by the queued component client before the log event message is written into an event log.

37. The system of claim 36, wherein the means for receiving the event notification further comprises means for placing the log event message in a client site event queue by the queued component client.

38. The system of claim 37, wherein the means for receiving the event notification further comprises means for creating the client site event queue by the queued component client.

39. The system of claim 33, wherein the means for receiving the event notification further comprises means for receiving the event notification by the queued component client from the management instrumentation application when a log event occurs.

40. The system of claim 30, wherein the means for sending the event message further comprises means for sending a log event message in extensible markup language to the server site event queue by the queued component client.

41. The system of claim 40, wherein the means for sending the log event message further comprises means for placing the log event message in a client site event queue by the queued component client.

42. The system of claim 41, wherein the means for placing the log event message in the client site event queue further comprises means for creating the client site event queue by the queued component client

43. The system of claim 40, wherein the means for sending the log event message further comprises means for sending the log event message to the server site event queue over a network.

44. The system of claim 43, wherein the means for sending the log event message over the network further comprises means for sending the log event message to the server site event queue over a proprietary network.

45. The system of claim 43, wherein the means for sending the log event message over the network further comprises means for sending the log event message to the server site event queue over a public network.

46. The system of claim 30, wherein the means for removing the event message further comprises means for removing a log event message from the server site event queue by the queued component server.

47. The system of claim 46, wherein the means for removing the log event message further comprises means for removing the log event message in extensible markup language format from the server site event queue by the queued component server.

48. The system of claim 47, wherein the means for removing the log event message further comprises means for removing the log event message from the server site event queue by the queued component server acting as an event processor.

49. The system of claim 30, wherein the means for storing the event message further comprises means for storing a log event message into the database by the queued component server.

50. The system of claim 49, wherein the means for storing the log event message further comprises means for storing the log event message in extensible markup language format into the database by the queued component server.

51. The system of claim 50, wherein the means for storing the log event message further comprises means for storing the log event message into a structured query language server data warehouse by the queued component server.

52. The system of claim 51, wherein the means for storing the log event message further comprises means for analyzing the stored log event message.

53. The system of claim 52, wherein the means for analyzing the stored log event message further comprises means for analyzing the stored log event message using an online analytical processing application.

54. The system of claim 30, further comprising means for allowing a user to query the database via a web browser user interface.

55. The system of claim 54, wherein the means for allowing the user to query the database further comprises means for filtering query results based on selections entered by the user on the user interface.

56. The system of claim 55, wherein the means for filtering the query results further comprises means for displaying a report of the filtered results for the user via the user interface.

57. The method of claim 30, further comprising means for sending a notice of a security related event as an event notification to a predefined terminal for a system administrator.

58. The method of claim 57, wherein the means for sending the notice of the security related event further comprises means for detecting the security event by a filtering mechanism associated with the database.
